(19) United States
(12) Patent Application Publication
(10) Pub. No.: US 2014/0096082 A1
(43) Pub. Date: Apr. 3, 2014

(54) DISPLAY TERMINAL AND METHOD FOR DISPLAYING INTERFACE WINDOWS

(71) Applicant: TENCENT TECHNOLOGY (SHENZHEN) COMPANY LIMITED, Shenzhen (CN)

(72) Inventors: SHI ZHEN, Shenzhen (CN); FENG WANG, Shenzhen (CN); YI ZHAO, Shenzhen (CN); FANG FANG, Shenzhen (CN); XIMIN YU, Shenzhen (CN); MEINUO LI, Shenzhen (CN)

(73) Assignee: TENCENT TECHNOLOGY (SHENZHEN) COMPANY LIMITED, Shenzhen (CN)

(21) Appl. No.: 14/099,205

(22) Filed: Dec. 6, 2013

Related U.S. Application Data
(63) Continuation of application No. PCT/CN2013/083611, filed on Sep. 17, 2013.

(30) Foreign Application Priority Data
Sep. 24, 2012 (CN) 201210357938.X

(51) Int. Cl. G06F 3/0485; G06F 3/0484; G06F 3/0482

(52) U.S. Cl. CPC G06F 3/0485; G06F 3/0482; G06F 3/04842
USPC 715/830

(57) ABSTRACT

Display terminals and methods for displaying interface windows are provided. In an exemplary method, at least two interface window thumbnails can be obtained and stacked to display. A display instruction can then be received. According to the display instruction, the at least two interface window thumbnails can be displayed by page-turning. Accordingly, a display terminal can include a thumbnail generating module, a displaying module, an instruction control module.

### CROSS-REFERENCES TO RELATED APPLICATIONS

This application is a continuation application of PCT Patent Application No. PCT/CN2013/083611, filed on Sep. 17, 2013, which claims priority to Chinese Patent Application No. CN201210357938X, filed on Sep. 24, 2012, the entire contents of all of which are incorporated herein by reference.

### FIELD OF THE DISCLOSURE

The present disclosure relates to the field of terminal preview technology and, more particularly, relates to methods for displaying interface windows and related display terminals, providing a convenient manner to preview a plurality of interface windows with easy operation and rapid positioning.

### BACKGROUND

Recently, more web-browsing is conducted using a mobile phone (vs. using computer) as a display terminal. However, mobile phones have small screens as compared with computers. Interface design for network browser used on a mobile phone is different from when used on a computer. For example, tabs can be used for a browser installed on the computer to facilitate users to quickly switch between multiple windows for browsing.

Multi-window browsing placed on a single page is also developed for mobile browsers, as shown in FIG. 1(a)-1(b). For example, FIG. 1(a) shows a conventional multi-window preview on mobile phones. As shown, such browser can display multi-windows 10, 20, on a single page 1. The dashed arrow shown in FIG. 1(a) indicates an operation of the mobile browser by sliding the screen in a left-right direction, which allows other windows to be seen. Often, it can only show one or two (e.g., windows 10 and 20 in FIG. 1(a)) windows. Switching windows is not efficient and window positioning is slow.

FIG. 1(b) shows another conventional multi-window preview on mobile phones. As shown, such browser can display multi-windows 30, 40, on a single page 2. However, each window 30, 40, can only see name and URL as shown in FIG. 1(b), and thus lack of graphical views to facilitate users with operational intuition. Especially when the name and the URL of the interface window is too long, which is in fact a common case, the user may not be able to completely view and readout desired information only from the name and the URL of the interface window shown on the screen. Although this type of design may improve efficiency for switching between windows but no graphical views involved to facilitate users with operational intuition.

Therefore, methods for previewing multi-windows operated on a mobile phone are desired for easy to preview and operate the multi-windows with fast positioning.

### BRIEF SUMMARY OF THE DISCLOSURE

According to various embodiments, there is provided a method for displaying interface windows on a display terminal. In this method, at least two interface window thumbnails can be obtained and stacked to display. A display instruction can then be received. According to the display instruction, the at least two interface window thumbnails can be displayed by page-turning.

According to various embodiments, there is also provided a display terminal. The display terminal can include a thumbnail generating module, a displaying module, and an instruction control module. The thumbnail generating module can be configured to obtain at least two interface window thumbnails. The displaying module can be configured to stack the at least two interface window thumbnails to display. The instruction control module can be configured to receive a display instruction. According to the display instruction, the displaying module can display the at least two interface window thumbnails by page-turning.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIGS. 1(a)-1(b) show conventional multi-window previews on mobile phones;

FIG. 2(a) depicts an initial state for an exemplary method of displaying interface windows in accordance with various disclosed embodiments;

FIG. 2(b) depicts an operating status for previewing a plurality of interface windows in an exemplary method for displaying interface windows in accordance with various disclosed embodiments;

FIG. 2(c) depicts a deleting operation when previewing a plurality of interface windows in an exemplary method for displaying an interface window in accordance with various disclosed embodiments;

FIG. 3 depicts an exemplary display terminal in accordance with various disclosed embodiments;

FIG. 4 depicts a flow diagram illustrating an exemplary display terminal and an exemplary method for displaying interface windows in accordance with various disclosed embodiments;

FIG. 5 depicts an exemplary environment incorporating certain disclosed embodiments; and

FIG. 6 depicts an exemplary server consistent with the disclosed embodiments.

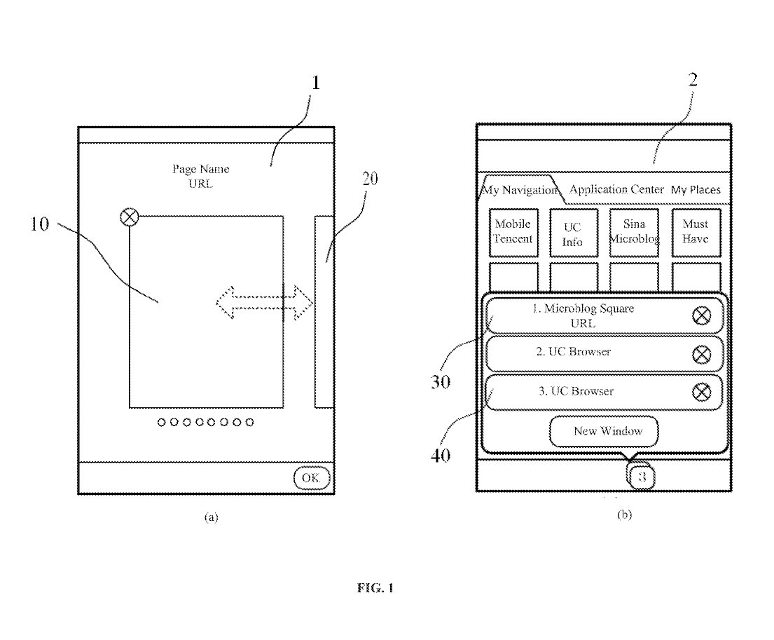

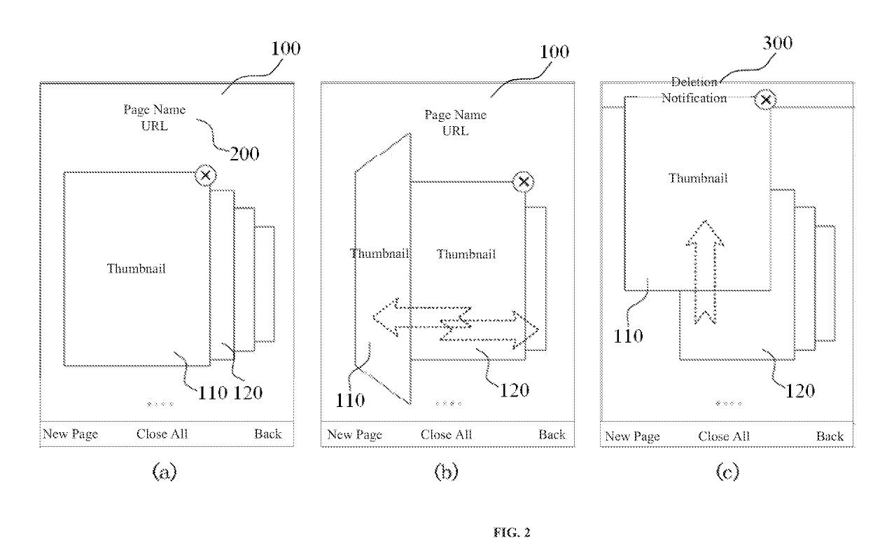

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

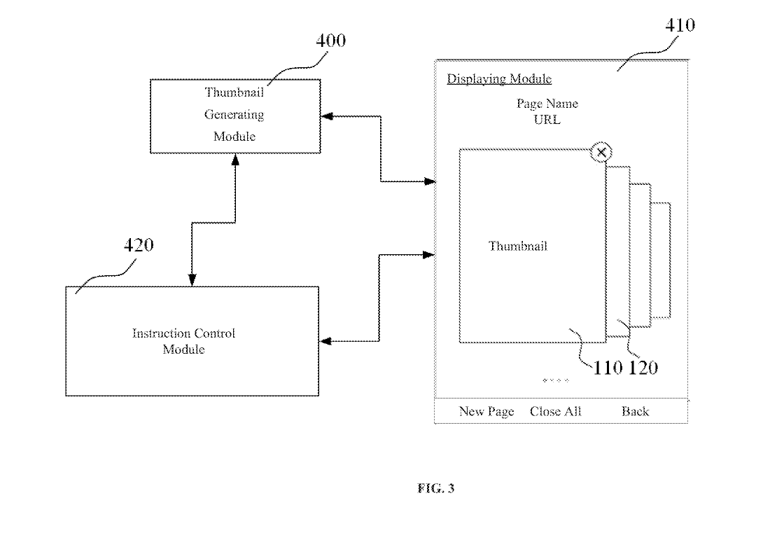

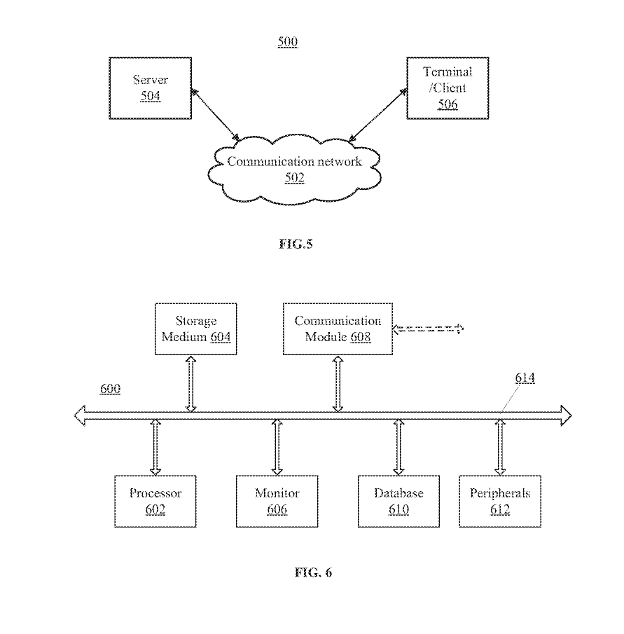

FIGS. 2-4 depict exemplary display terminals and exemplary methods for displaying interface windows in accordance with various disclosed embodiments. The exemplary display terminals and methods can be implemented, for example, in an exemplary environment 500 as shown in FIG. 5.

As shown in FIG. 5, the environment 500 can include a server 504, a terminal 506, and a communication network 502. The server 504 and the terminal 506 may be coupled through the communication network 502 for information exchange, for example, Internet searching, webpage browsing, etc. Although only one terminal 506 and one server 504 are shown in the environment 500, any number of terminals 506 or servers 504 may be included, and other devices may also be included.

The communication network 502 may include any appropriate type of communication network for providing network connections to the server 504 and terminal 506 or among multiple servers 504 or terminals 506. For example, the communication network 502 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be interchangeably used. In various embodiments, the terminal 506 can include the disclosed display terminal, which can implement the disclosed methods for displaying multi-interface windows. As used herein, unless otherwise specified, the terms “window” and “interface window” can be interchangeably used.

A server, as used herein, may refer one or more server computers configured to provide certain server functionalities, for example, search engines and database management. A server may also include one or more processors to execute computer programs in parallel.

The server 504 and the terminal 506 may be implemented on any appropriate computing platform. FIG. 6 shows a block diagram of an exemplary computing system 600 capable of implementing the server 504 and/or the terminal 506. As shown in FIG. 6, the exemplary computer system 600 may include a processor 602, a storage medium 604, a monitor 606, a communication module 608, a database 610, peripherals 612, and one or more bus 614 to couple the devices together. Certain devices may be omitted and other devices may be included.

The processor 602 can include any appropriate processor or processors. Further, the processor 602 can include multiple cores for multi-thread or parallel processing. The storage medium 604 may include memory modules, for example, ROM, RAM, and flash memory modules, and mass storages, for example, CD-ROM, U-disk, removable hard disk, etc. The storage medium 604 may store computer programs for implementing various processes, when executed by the processor 602.

Further, the peripherals 612 may include I/O devices, for example, keyboard and mouse, and the communication module 608 may include network devices for establishing connections through the communication network 502. The database 610 may include one or more databases for storing certain data and for performing certain operations on the stored data, for example, webpage browsing, database searching, etc.

In operation, the terminal 506 may cause the server 504 to perform certain actions, for example, an Internet search or other database operations. The server 504 may be configured to provide structures and functions for such actions and operations. More particularly, the server 504 may include a data searching system for real-time database searching. In various embodiments, a terminal, for example, a mobile terminal involved in the disclosed methods and systems can include the terminal 506.

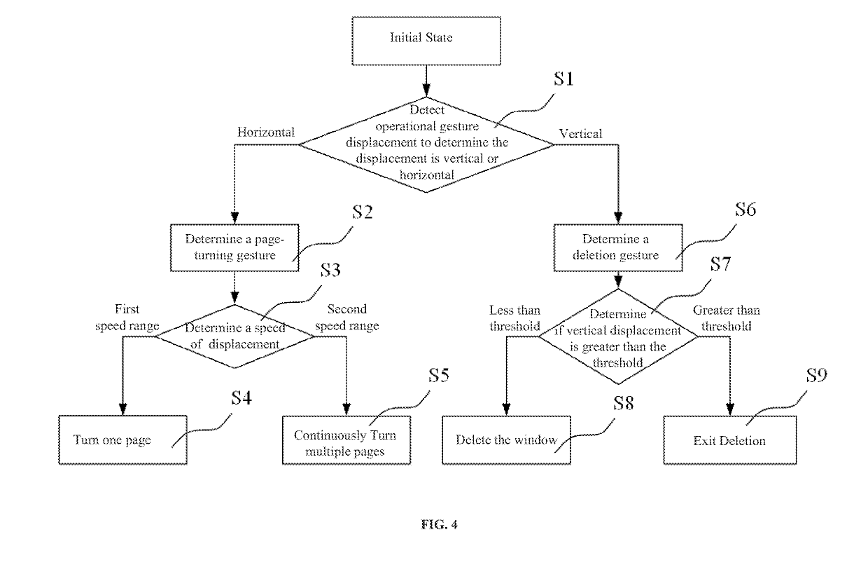

Referring to FIGS. 2(a)-2(c) and FIG. 4, the exemplary display terminal depicted in FIG. 4 includes a thumbnail generating module 400, a displaying module 410, and/or an instruction control module 420.

The thumbnail generating module 400 is configured to obtain at least two interface window thumbnails, e.g., interface window thumbnails 110, 120 as shown in FIG. 2(a). The displaying module 410 is configured to stack (e.g., overlay) and display the at least two interface window thumbnails, e.g., the interface window thumbnails 110, 120. The instruction control module 420 is configured to receive display instructions inputted by a user. The displaying module 410 can achieve page-turning display of the at least two interface window thumbnails 110, 120 according to the display instruction inputted by the user.

The disclosed display terminal can have a screen, for example, a mobile phone screen, which can have a touch-screen control, optical screen control, etc. The disclosed display terminal can be able to receive data for displacement of operational gestures on the screen. Of course, the present disclosure is not limited to the operational gestures, any operational means for interface input between man-machine can be encompassed herein.

As shown in FIG. 2(a) where a user opens browser application software and the initial state can include multiple browsed interface windows opened by the user in the disclosed display terminal and in the disclosed method for displaying interface windows.

The displaying module 410 can allow multiple interface windows to be displayed on the screen, for example, on a page 100 shown in FIG. 2(a). Each interface window can be an individual thumbnail obtained by the thumbnail generating module 400. The interface windows can include, e.g., a first interface window thumbnail 110, a second interface window thumbnail 120, etc.

Meanwhile, on page 100 of the displaying module 410, an interface window identification of the uppermost first interface window thumbnail 110 can be displayed including, e.g., name and the URL 200 of the interface window. Each of the thumbnails following the first interface window thumbnail 110 can be arranged to be sequentially stacked under a previous thumbnail. As shown in FIG. 2(A), all of the interface window thumbnails 110, 120, etc. are displayed in a manner of three-dimensional animation stacking.

Displaying by three-dimensional animation stacking can display the interface window thumbnails 110, 120, etc. with different z-coordinate by setting the displaying module 410, such that the interface window thumbnails 110, 120, etc. can show different depth of field. In addition, the interface window thumbnails 110, 120, etc. can be set by the displaying module 410 to have different perspectives, allowing users to better experience layers of the three-dimension.

In FIG. 2(b), when the user operates the disclosed display terminal to preview multiple interface windows within a single page, the instruction control module 420 can determine whether a coordinate movement direction of a gesture displacement is in a first direction range or in a second direction range. As disclosed, a substantially horizontal direction can be a first range of directions; and a substantially vertical direction can be a second range of directions.

As indicated by arrows in FIG. 2(b), when the gesture displacement slides to the left (or sometimes to the right), alike turning pages in a book, the first interface window thumbnail 110 on top of the stacked thumbnails can turn (or flip) by a certain angle. Meanwhile, the z-coordinate of the second interface window thumbnail 120, originally under the first interface window thumbnail 110, can be adjusted to be moved up to be displayed to the user.

The displaying module 410 can delete the originally-uppermost stacked first interface window thumbnail 110 by a gesture displacement. For this deletion, the user can see the originally-uppermost stacked first interface window thumbnail 110 is removed from this page and the second interface window thumbnail 120 is moved up and displayed uppermost on the stack of thumbnails. Of course, at this time, the displaying module 410 can display interface window identification (e.g., logo) of the second interface window thumbnail 120 including, for example, name and URL 200 of the interface window thumbnail 120.

In addition, when the instruction control module 420 determines a gesture displacement is in a range of the first direction, for example, in a substantially horizontal direction, a speed threshold with respect to the displacement is used to determine the substantially horizontal displacement of the gesture is in the first speed range or a second speed range. If the instruction control module 420 determines the gesture displacement is in the first speed range, e.g., at a slow speed, with the gesture, the first interface window thumbnail 110 can move slowly along with the gesture displacement. If the instruction control module 420 determines the gesture displacement is in the second speed range, e.g., at a fast speed, then based on the displacement value of the operational gesture, a turning page display having a corresponding number of the interface window thumbnails can be performed.

For example, when a displacement distance of the operational gesture is short enough, the first interface window thumbnail 110 can be rapidly turned (or flipped). When the displacement distance of the operational gesture is long enough, via the three-dimensional transformation matrix, a page turning display showing rapidly flipping multiple thumbnails can be displayed.

In FIG. 2(c), on a single page of the disclosed display terminal, the user can perform a deletion operation of the first interface window thumbnail 110 on one window. When a displacement of the operational gesture of the user is in the second direction range, for example, in a substantially vertical direction, and the displacement of a user's gesture is indicted by the arrow. When sliding upward, the first interface window thumbnail 110 can move along with a displacement direction of the user's gesture, and can change degree of transparency along with the gesture displacement.

In the disclosed display terminals and methods for displaying interface window(s), a threshold can be pre-set. The threshold is a coordinate position pre-set in the second direction range, for example, the threshold may be a y-coordinate value pre-set on the screen of a mobile phone.

When the instruction control module 420 determines that an ending position of the gesture displacement is less than this threshold value, as shown in FIG. 2(C), it is determined the first interface window thumbnail 110 moves beyond a region of the deletion notification 300. The displaying module 410 deletes the first interface window thumbnail 110 and makes it disappear. Other windows following the first interface window thumbnail 110 can then be sequentially moved up, for example, the second interface window thumbnail 120 can become an uppermost interface window thumbnail.

When the instruction control module 420 determines that an ending position of the gesture displacement is greater than the threshold value, i.e., the first interface window thumbnail 110 does not move beyond the region of the deletion notification 300. The first interface window thumbnail 110 can bounce back and restore to its original state.

Of course, the region of the deletion notification 300 can be set to display on the bottom of the screen, such that the ending position of the gesture displacement is greater than this threshold value. The instruction control module 420 determines whether the first interface window thumbnail 110 moves beyond the region of the deletion notification 300. The first interface window thumbnail 110 disappears. The thumbnails following the first interface window thumbnail 110 can sequentially move up, for example, the second interface window thumbnail 120 can become the uppermost thumbnail.

When the instruction control module 420 determines that an ending position of the gesture displacement is less than the threshold value, i.e., the first interface window thumbnail 110 does not move beyond the region of the deletion notification 300. The first interface window thumbnail 110 can bounce back and restore to its original state.

FIG. 4 depicts a flow diagram illustrating an exemplary display terminal and an exemplary method for displaying interface windows in accordance with various disclosed embodiments.

When a user opens browser application software, for example, the user has already opened multiple browsed interface windows, the thumbnail generating module 400 can obtain each individual interface window thumbnail, e.g., the first interface window thumbnail 110, the second interface window thumbnail 120, etc. The displaying module 410 can display the phone screen as shown in FIG. 2 (a), illustrating an initial state displaying a number of interface windows on one page. Individual interface window thumbnail 110, 120, etc. can be displayed. The number of interface windows can be displayed as three-dimensional animation stacking having the first interface window thumbnail 110 the uppermost.

In Step S1, the instruction control module 420 detects data of a displacement of an operational gesture from a user received by a mobile phone to determine that the displacement is substantially vertical or substantially horizontal.

In Step S2, when the displacement is determined to be substantially horizontal, the instruction control module 420 determines whether the received operation is a page turning gesture.

In Step S3, when the instruction control module 420 detects a speed of the displacement and determines a slow speed, then Step S4 is performed, the screen only displays turning of the first interface window thumbnail 110. When the instruction control module 420 detects a speed of the displacement and determines a fast speed, then Step S5 is performed, the screen only displays turning of the first interface window thumbnail 110 followed by a number of other thumbnails, e.g., a second interface window thumbnail 120.

Of course, before performing Step S3, a pre-set speed threshold can be included. A first speed range and a second speed range can be distinguished to determine whether the horizontal displacement is in a first speed range (e.g., slow) or in a second speed range (e.g., fast).

Further, if the displacement is determined substantially vertical in Step S1, Step S6 can be performed. It is determined that the received operation includes a deleting gesture. Then, Step S7 is performed, the instruction control module 420 determines whether a vertical displacement is greater than a preset threshold. The threshold can be a y-coordinate value pre-set on the screen of the mobile phone.

In Step S8, when the ending position of a displacement is less than a threshold value, the displaying module 410 can delete the first interface window thumbnail 110. The first interface window thumbnail 110 then disappears.

In Step S9, when the ending position of the displacement is greater than the threshold, then the deletion exits. The displaying module 410 allows the first interface window thumbnail 110 to be restored to its original display state.

In the disclosed display terminals and interface window display method, displaying with page turning and three-dimensional animation can allow users to use their intuition, and more intuitively display images of operations. This can efficiently facilitate users to preview multiple interface windows with rapid positioning.

It should be noted that, in the present disclosure each embodiment is progressively described, i.e., each embodiment is described and focused on difference between embodiments. Similar and/or the same portions between various embodiments can be referred to with each other. In addition, exemplary apparatus is described with respect to corresponding methods.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The present disclosure relates to the field of terminal preview technology and, more particularly, relates to methods for displaying interface windows and related display terminals, providing a convenient manner to preview a plurality of interface windows with easy operation and rapid positioning.

In the disclosed display terminals and interface window display method, displaying with page turning and three-dimensional animation can allow users to use their intuition, and more intuitively display images of operations. This can efficiently facilitate users to preview multiple interface windows.

What is claimed is:

1. A method for displaying interface windows on a display terminal comprising:
obtaining at least two interface window thumbnails;
stacking the at least two interface window thumbnails to display; and
receiving a display instruction; and
displaying the at least two interface window thumbnails by page-turning according to the display instruction.

2. The method of claim 1, wherein the display instruction comprises a displacement received by the display terminal.

3. The method of claim 2, further comprising:
determining whether a coordinate movement direction of the displacement of a gesture is in a first direction range or in a second direction range.

4. The method of claim 3, wherein, when the displacement is in the first direction range, the method further comprises:
determining whether a speed of the displacement is in a first speed range or in a second speed range, and
page-turning a first interface window thumbnail of the at least two interface window thumbnails to display, when the speed of the displacement is in the first speed range, or
page-turning the at least two interface window thumbnails to display, when the speed of the displacement is in the second speed range.

5. The method of claim 4, wherein when the speed of the displacement is in the second speed range, the method further comprises:
page-turning a number of interface window thumbnails selected from the at least two interface window thumbnails to display, wherein the number corresponds to a number of the displacement.

6. The method of claim 4, wherein the page-turning of the at least two interface window thumbnails to display comprises:
simultaneously displaying interface window identification corresponding to the at least two interface window thumbnails, wherein the interface window identification comprises a name and a url.

7. The method of claim 3, wherein, when the displacement is in the second direction range, the method further comprises:
a first interface window thumbnail of the at least two interface window thumbnails moves in a direction along with a coordinate movement direction of the displacement.

8. The method of claim 7, wherein, when an ending position of the displacement is less than a threshold, the method further comprises:
deleting the first interface window thumbnail from the at least two interface window thumbnails.

9. The method of claim 8, wherein the threshold is a coordinate position pre-set in the second direction range.

10. A display terminal comprising:
a thumbnail generating module, configured to obtain at least two interface window thumbnails;
a displaying module, configured to stack the at least two interface window thumbnails to display;
an instruction control module, configured to receive a display instruction, wherein the displaying module displays the at least two interface window thumbnails by page-turning according to the display instruction.

11. The display terminal of claim 10, wherein the display instruction comprises a displacement of a gesture that a user input to an instruction control module of the display terminal.

12. The display terminal of claim 11, wherein the instruction control module is configured to determine whether a coordinate movement direction of the displacement is in a first direction range or in a second direction range.

13. The display terminal of claim 12, wherein the instruction control module is configured to determine whether a speed of the displacement is in a first speed range or in a second speed range, and wherein
when the speed of the displacement is in the first speed range, the displaying module page-turns a first interface window thumbnail of the at least two interface window thumbnails to display, or
when the speed of the displacement is in the second speed range, the displaying module page-turns the at least two interface window thumbnails to display.

14. The display terminal of claim 13, wherein when the instruction control module determines the speed of the displacement is in the second speed range, the displaying module page-turns a number of interface window thumbnails selected from the at least two interface window thumbnails to display, wherein the number corresponds to a number of the displacement.

15. The display terminal of claim 13, wherein when the displaying module page-turns the at least two interface window thumbnails to display, the displaying module simultaneously displays interface window identification corresponding to the at least two interface window thumbnails, wherein the interface window identification comprises a name and a url.

16. The display terminal of claim 12, wherein, when the instruction control module determines the displacement is in the second direction range, the displaying module allows a first interface window thumbnail of the at least two interface window thumbnails to move in a direction along with a coordinate movement direction of the displacement.

17. The display terminal of claim 16, wherein, when the instruction control module determines an ending position of the displacement is less than a threshold, the displaying module delete the first interface window thumbnail from the at least two interface window thumbnails.

18. The display terminal of claim 17, wherein the threshold is a coordinate position pre-set in the second direction range.
